(19) United States
(12) Patent Application Publication
(10) Pub. No.: US 2026/0204001 A1
(43) Pub. Date: Jul. 16, 2026

(54) GENERATING THREE-DIMENSIONAL IMAGES USING MACHINE LEARNING AND GENERATIVE ARTIFICIAL INTELLIGENCE

(71) Applicant: Dell Products L.P., Round Rock, TX (US)

(72) Inventors: Bin He, Shanghai (CN); Zijia Wang, London (GB); Zhen Jia, Shanghai (CN)

(21) Appl. No.: 18/893,329

(22) Filed: Sep. 23, 2024

(51) Int. Cl. G06T 15/20; G06T 15/04; G06V 10/82

(52) U.S. Cl. CPC G06T 15/205; G06T 15/04; G06V 10/82

(57) ABSTRACT

Methods, apparatus, and processor-readable storage media for generating 3D images using machine learning and generative artificial intelligence are provided herein. An example computer-implemented method includes obtaining at least one 2D image; determining one or more features of the at least one 2D image by processing at least a portion of the at least one 2D image using a first machine learning technique; generating multiple 3D visualizations associated with the at least a portion of the at least one 2D image by processing at least a portion of the one or more features using one or more generative artificial intelligence techniques; selecting at least one of the multiple 3D visualizations by processing at least a portion of the multiple 3D visualizations using a second machine learning technique different from the first machine learning technique; and performing one or more automated actions based on the at least one selected 3D visualization.

### BACKGROUND

Three-dimensional (3D) visualization of objects and/or two-dimensional (2D) images is increasingly sought across many types of uses cases. However, conventional techniques for generating 3D images face significant problems such as, e.g., a lack of depth information and presence of occlusions, shadows, and/or noise, resulting in suboptimal outputs.

### SUMMARY

Illustrative embodiments of the disclosure provide techniques for generating 3D images using machine learning and generative artificial intelligence.

An exemplary computer-implemented method includes obtaining at least one 2D image, and determining one or more features of the at least one 2D image by processing at least a portion of the at least one 2D image using a first machine learning technique. The method also includes generating multiple 3D visualizations associated with the at least a portion of the at least one 2D image by processing at least a portion of the one or more features using one or more generative artificial intelligence techniques. Further, the method additionally includes selecting at least one of the multiple 3D visualizations by processing at least a portion of the multiple 3D visualizations using a second machine learning technique different from the first machine learning technique, and performing one or more automated actions based at least in part on the at least one selected 3D visualization.

Illustrative embodiments can provide significant advantages relative to conventional 3D image generation techniques. For example, problems associated with a lack of depth information and presence of occlusions, shadows, and/or noise are overcome in one or more embodiments through generating 3D images by processing 2D images using a combination of deep learning, generative artificial intelligence, and active learning techniques.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for generating 3D images using machine learning and generative artificial intelligence in an illustrative embodiment.

FIG. 2 shows example architecture for an automated 3D visualization generation system in an illustrative embodiment.

FIG. 3 is a flow diagram of a process for generating 3D images using machine learning and generative artificial intelligence in an illustrative embodiment.

FIGS. 4 and 5 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

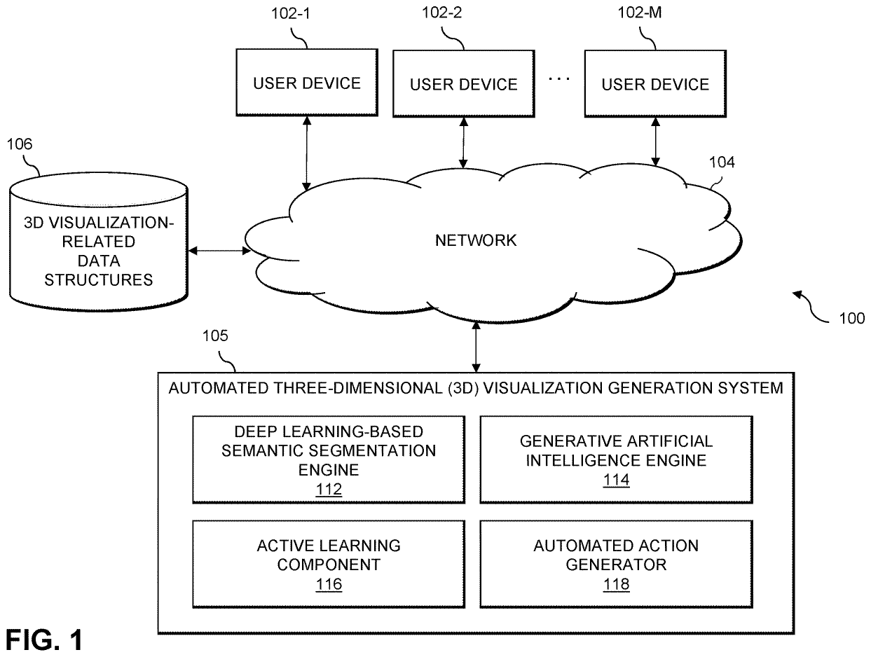

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated 3D visualization generation system 105.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the automated 3D visualization generation system 105 can have one or more associated 3D visualization-related data structures 106 configured to store data pertaining to features of 2D images, texture data pertaining to 2D images and/or 3D visualizations, shape data pertaining to 2D images and/or 3D visualizations, 3D visualization instance data, etc. The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

The 3D visualization-related data structures 106 in the present embodiment are implemented using one or more storage systems associated with the automated 3D visualization generation system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the automated 3D visualization generation system 105 are one or more input-output devices, which illustratively comprise keyboards, displays or other types of input-output devices in any combination. Such input-output devices can be used, for example, to support one or more user interfaces to the automated 3D visualization generation system 105, as well as to support communication between the automated 3D visualization generation system 105 and other related systems and devices not explicitly shown.

Additionally, the automated 3D visualization generation system 105 in the FIG. 1 embodiment is assumed to be implemented using at least one processing device. Each such processing device generally comprises at least one processor and an associated memory, and implements one or more functional modules for controlling certain features of the automated 3D visualization generation system 105.

More particularly, the automated 3D visualization generation system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the automated 3D visualization generation system 105 to communicate over the network 104 with the user devices 102, and illustratively comprises one or more conventional transceivers.

The automated 3D visualization generation system 105 further comprises deep learning-based semantic segmentation engine 112, generative artificial intelligence engine 114 (e.g., one or more generative adversarial networks (GANs)), active learning component 116, and automated action generator 118.

It is to be appreciated that this particular arrangement of elements 112, 114, 116 and 118 illustrated in the automated 3D visualization generation system 105 of the FIG. 1 embodiment is presented by way of example only, and alternative arrangements can be used in other embodiments. For example, the functionality associated with elements 112, 114, 116 and 118 in other embodiments can be combined into a single module, or separated across a larger number of modules. As another example, multiple distinct processors can be used to implement different ones of elements 112, 114, 116 and 118 or portions thereof.

At least portions of elements 112, 114, 116 and 118 may be implemented at least in part in the form of software that is stored in memory and executed by a processor.

It is to be understood that the particular set of elements shown in FIG. 1 for generating 3D images using deep learning, generative artificial intelligence, and active learning techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of automated 3D visualization generation system 105, 3D visualization-related data structures 106, and user devices 102 can be on and/or part of the same processing platform.

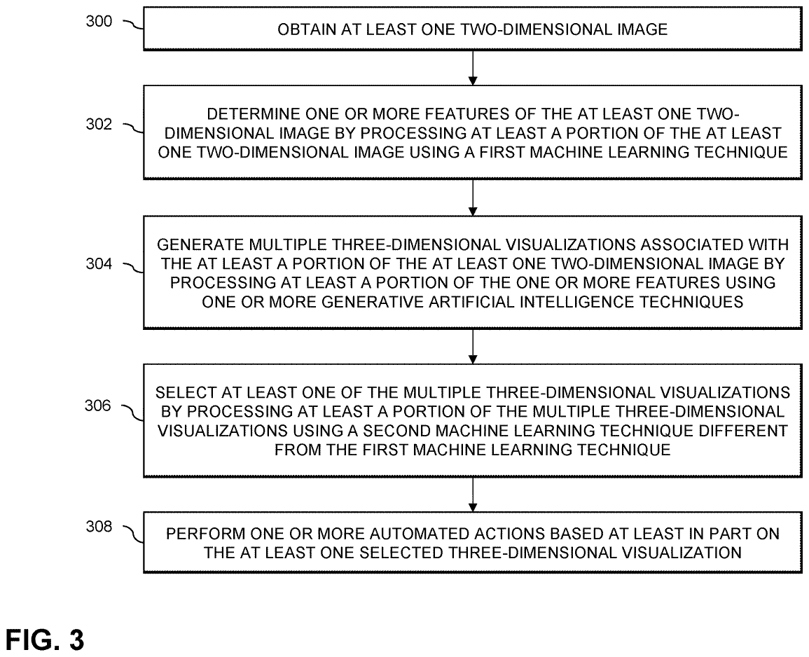

An exemplary process utilizing elements 112, 114, 116 and 118 of an example automated 3D visualization generation system 105 in computer network 100 will be described in more detail with reference to the flow diagram of FIG. 3.

Accordingly, at least one embodiment includes generating enhanced 3D visualizations of objects and/or 2D images by leveraging one or more GANs, one or more semantic segmentation techniques, and one or more active learning techniques in a deep learning framework. Also, in contrast to disadvantageous conventional approaches, such an embodiment includes reducing the costs and/or resources associated with generating 3D visualizations, in addition to generating improved 3D visualizations.

As detailed herein, at least one embodiment includes implementing a combination of one or more GANs, one or more semantic segmentation techniques, and one or more active learning techniques for 3D reconstruction from at least one image (e.g., a single 2D image). Additionally, such an embodiment can include using at least one adversarial loss function in a GAN architecture in connection with generating 3D visualizations. Further, such an embodiment includes using one or more semantic segmentation techniques to capture details of the object and/or 2D image, and using one or more active learning techniques to select the most informative and/or challenging instances (e.g., instances of corresponding 3D renderings of the 2D image) for learning, accelerating the learning process and enhancing the model's accuracy (e.g., the GAN's accuracy). As noted above and herein, the task of 3D reconstruction from a single 2D image poses multiple challenges. For example, transforming a 3D object into a 2D image results in a loss of depth information, and recovering the accurate 3D structure of the object from a single 2D viewpoint as part of a 3D reconstruction presents challenges. Also, real-world images often contain occlusions, shadows, and/or noise that can complicate a 3D reconstruction process. For instance, parts of an object may be hidden in a 2D image, shadows may alter the apparent shape of the object, sensor noise can lead to inaccurate color and/or texture, etc. Additionally, objects come in a wide variety of shapes, sizes, colors, textures, etc., and this variability makes it challenging to develop a generalizable model that can accurately reconstruct the 3D shape of a given object from a single image.

Accordingly, one or more embodiments include addressing such challenges and producing high-quality, realistic 3D visualizations of objects from single 2D images. Such an embodiment includes combining one or more GANs, one or more semantic segmentation techniques, and one or more active learning techniques in at least one deep learning framework, providing significant improvements in 3D reconstruction of objects from single images. Further, as additionally detailed herein, at least one embodiment includes performing 3D reconstruction from single 2D images by integrating shape generation techniques, appearance rendering techniques, and semantic segmentation techniques.

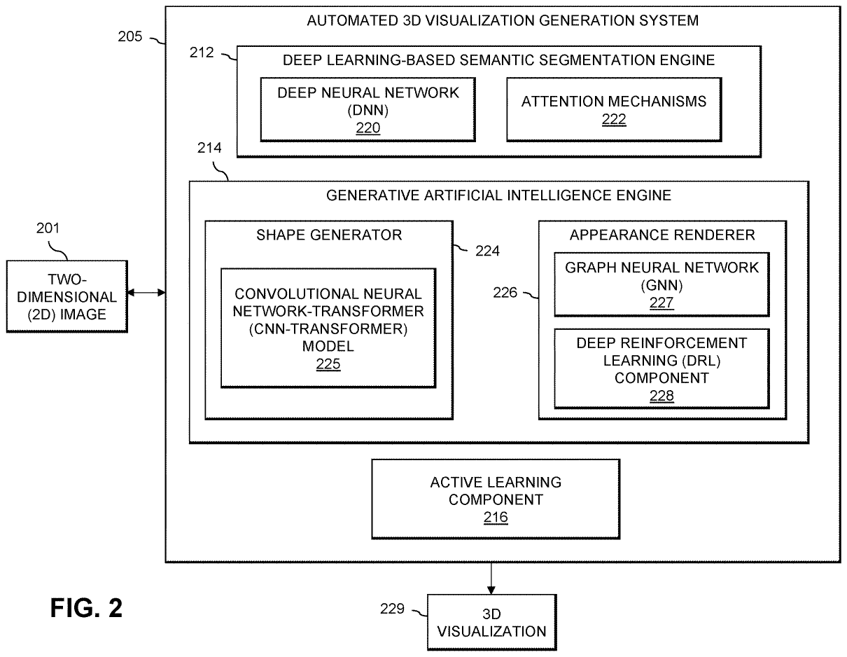

FIG. 2 shows example architecture for an automated 3D visualization generation system in an illustrative embodiment. By way of illustration, FIG. 2 depicts automated 3D visualization generation system 205 processing a 2D image 201 and generating a 3D visualization related and/or corresponding thereto. More particularly, such processing includes utilizing deep learning-based semantic segmentation engine 212, generative artificial intelligence engine 214, and active learning component 216.

Within generative artificial intelligence engine 214, such an embodiment can include implementing at least one shape generator 224 which includes a hybrid convolutional neural network-transformer (CNN-transformer) model 225. More particularly, in such an embodiment, shape generator 224 employs hybrid CNN-transformer model 225, G_{hybrid}, to produce detailed voxel representations from single images (e.g., 2D image 201). Further, such an embodiment includes combining the spatial hierarchy capabilities of CNNs with the global contextual understanding of transformers, enhancing geometric and textural fidelity of generated shapes.

As noted and further detailed herein, one or more embodiments include utilizing at least one transformer-based shape generator model in conjunction with a CNN. Such a hybrid model, denoted as G_{hybrid}, leverages the CNN's capability to capture spatial hierarchies and the transformer's ability to understand global dependencies within an image. Accordingly, in such an embodiment, an input 2D image (e.g., 2D image 201), I_{2D}, is processed by the hybrid model (e.g., hybrid CNN-transformer model 225) to generate a detailed voxel representation, V_{detailed}, capturing nuanced geometric and textural information of the 2D image. The loss function, L_{hybrid}, for such a shape generator can be defined as follows in Equation (1):

$${L}_{hybrid} ( {G}_{hybrid} ) = α {L}_{geom} ( {V}_{detailed} , {V}_{target} ) + β {L}_{texture} ( {V}_{detailed} , {I}_{2 D} ) \qquad ( 1 )$$

wherein L_{geom} minimizes the geometric discrepancy between the generated and target voxel representations, Lₜₑₓₜᵤᵣₑ ensures texture fidelity by comparing the generated voxel representation's texture with that of the original image, and α and β are weighting factors. A dual-focus loss function can also be implemented to further emphasize the importance of both geometry and texture in creating high-quality 3D shapes from single images.

Additionally, in one or more embodiments, generative artificial intelligence engine 214 also implements at least one appearance renderer 226, which includes at least one graph neural network (GNN) 227 and at least one deep reinforcement learning (DRL) component 228. More particularly, in such an embodiment, appearance renderer 226, G_{advanced}, utilizes the at least one GNN 227 for a nuanced interpretation of one or more textures of the given object and/or 2D image (e.g., 2D image 201), and utilizes the at least one DRL component 228 for adaptive texture refinement. Such an embodiment ensures a significant level of fidelity between rendered 3D visualizations (e.g., 3D visualization 229) and their real world counterparts under various conditions.

As noted and further detailed herein, one or more embodiments include utilizing at least one GNN-based appearance renderer (e.g., appearance renderer 226), G_{advanced}, for determining the texture and appearance rendering of one or more 3D visualizations, which enables a nuanced interpretation of texture details, adapting to the complex interplays of light and material properties. Coupled with at least one DRL component 228, such an appearance renderer 226 dynamically refines texture mapping, ensuring fidelity between the rendered 3D visualization (e.g., 3D visualization 229) and its real-world counterpart. In such an embodiment, an appearance rendering process can be defined in Equation (2) as follows:

$${L}_{advanced} ( {G}_{advanced} ) = γ {L}_{texture} ( {M}_{refined} , {I}_{2 D} ) + δ {L}_{DRL} ( {M}_{refined} , {Θ}_{env} ) \qquad ( 2 )$$

wherein Lₜₑₓₜᵤᵣₑ aims to reduce the discrepancy between the 3D visualization's texture and the input image's texture, L_{DRL} enhances and/or optimizes the texture parameters Φₑₙᵥ using reinforcement learning for environmental adaptability, and γ and δ are weighting factors.

Referring again to FIG. 2, at least one embodiment includes implementing enhanced semantic segmentation integration. More particularly, in such an embodiment, deep learning-based semantic segmentation engine 212 incorporates at least one deep neural network (DNN) 220 and one or more attention mechanisms 222. Accordingly, in such an embodiment, a semantic segmentation process, S_{enhanced}, dynamically focuses on relevant image features, improving segmentation accuracy. This not only refines the 3D reconstruction process but also ensures that one or more important image features are precisely captured, enhancing the overall quality of the 3D visualizations.

As noted and further detailed herein, one or more embodiments include integrating at least one DNN 220 with one or more attention mechanisms 222, denoted as S_{enhanced}. Such an integration allows for a refined analysis of the input image, I_{2D}, by dynamically focusing on one or more salient features relevant for accurate 3D shape generation. Also, in such an embodiment, a modified loss function, L_{enhanced}, can be used which incorporates an attention-guided segmentation loss, Lₐₜₜₑₙₜᵢₒₙ, to ensure that the generated 3D visualization, M_{3D}, accurately represents both the geometry and semantics of the target object. Accordingly, in such an embodiment, the enhanced semantic segmentation process is formulated via Equation (3) as follows:

$${S}_{train} = {S}_{sel} ( {D}_{train} , {I}_{info} ) \qquad ( 4 )$$

wherein L_{seg} is a traditional segmentation loss, Lₐₜₜₑₙₜᵢₒₙ is the attention mechanism loss ensuring focus on relevant features, and ϵ and ζ are weighting factors.

Additionally, as detailed herein, one or more embodiments further improve the efficiency of the 3D reconstruction framework (e.g., automated 3D visualization generation system 205) by incorporating at least one active learning component 216, which can enable active selection of one or more samples (e.g., the most informative samples) for training, thereby reducing training time and improving model performance (e.g., generative artificial intelligence engine performance). More particularly, such an embodiment can include defining an informativeness measure, I_{info}, and a selection function, Sₛₑₗ, that selects a subset (Sₜᵣₐᵢₙ) of the training data (Dₜᵣₐᵢₙ) based on I_{info} as detailed in Equation (4) as follows:

$${L}_{enhanced} ( {S}_{enhanced} ) = ϵ {L}_{seg} ( {M}_{3 D} , {I}_{2 D} ) + ζ {L}_{attention} ( {S}_{enhanced} , {I}_{2 D} ) \qquad ( 3 )$$

In at least one embodiment, the model can then be trained on Sₜᵣₐᵢₙ instead of Dₜᵣₐᵢₙ.

Accordingly, in one or more embodiments, the above-noted loss function(s) and informativeness measure(s) used in active learning can facilitate the generation of consistent and realistic 3D visualizations, and also enhance training efficiency and model performance. Further, at least one embodiment can be implemented in connection with various practical applications related to multiple domains including, e.g., online retailing, virtual reality, and augmented reality.

As detailed herein, such embodiments can include generating and/or implementing a deep learning framework that combines at least one shape generator and at least one appearance renderer to generate realistic 3D visualizations of one or more objects (e.g., retail goods) from one or more single images. Additionally, such an embodiment can include integrating semantic segmentation techniques into the shape generator network to improve the quality of the generated 3D shape, as well as incorporating at least one active learning technique to enhance the training efficiency and performance of the model. Further, one or more embodiments include using at least one adversarial loss function that enhances consistency across the generated 3D visualization(s) and the input image(s), and using at least one voxel representation as an intermediate step between the input image(s) and the output 3D visualization(s).

FIG. 3 is a flow diagram of a process for generating 3D images using machine learning and generative artificial intelligence in an illustrative embodiment. It is to be understood that this particular process is only an example, and additional or alternative processes can be carried out in other embodiments.

In this embodiment, the process includes steps 300 through 308. These steps are assumed to be performed by the automated 3D visualization generation system 105 utilizing elements 112, 114, 116 and 118.

Step 300 includes obtaining at least one 2D image. Step 302 includes determining one or more features of the at least one 2D image by processing at least a portion of the at least one 2D image using a first machine learning technique. In at least one embodiment, determining one or more features of the at least one 2D image includes processing the at least a portion of the at least one 2D image using one or more semantic segmentation techniques. In such an embodiment, processing the at least a portion of the at least one 2D image using one or more semantic segmentation techniques can include processing the at least a portion of the at least one 2D image using one or more deep neural networks in conjunction with one or more attention mechanisms.

Also, in at least one embodiment, determining one or more features of the at least one 2D image includes generating one or more voxel representations of at least portions of the at least one 2D image by processing the at least a portion of the at least one 2D image using at least one shape generator, wherein the at least one shape generator includes at least one convolutional neural network-transformer model. Additionally or alternatively, determining one or more features of the at least one 2D image can include determining one or more textures associated with at least portions of the at least one 2D image by processing the at least a portion of the at least one 2D image using at least one appearance renderer, wherein the at least one appearance renderer includes one or more graph neural networks and at least one deep reinforcement learning technique.

Step 304 includes generating multiple 3D visualizations associated with the at least a portion of the at least one 2D image by processing at least a portion of the one or more features using one or more generative artificial intelligence techniques. In one or more embodiments, generating multiple 3D visualizations associated with the at least a portion of the at least one 2D image includes processing the at least a portion of the one or more features using one or more generative adversarial networks. In such an embodiment, processing the at least a portion of the one or more features using one or more generative adversarial networks can include implementing at least one an adversarial loss function in connection with the one or more generative adversarial networks.

Step 306 includes selecting at least one of the multiple 3D visualizations by processing at least a portion of the multiple 3D visualizations using a second machine learning technique different from the first machine learning technique. In at least one embodiment, the first machine learning technique includes at least one deep learning algorithm, and the second machine learning technique includes at least one active learning technique. In such an embodiment, selecting at least one of the multiple 3D visualizations includes defining at least one informativeness measure and at least one selection function associated with the at least one active learning technique.

Step 308 includes performing one or more automated actions based at least in part on the at least one selected 3D visualization. In one or more embodiments, performing one or more automated actions includes automatically training at least a portion of the one or more generative artificial intelligence techniques using the at least one selected 3D visualization. Additionally or alternatively, performing one or more automated actions comprises automatically outputting, to one or more user devices associated with the at least one 2D image, the at least one selected 3D visualization.

Accordingly, the particular processing operations and other functionality described in conjunction with the flow diagram of FIG. 3 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to generate 3D images by processing one or more 2D images using a combination of deep learning, generative artificial intelligence, and active learning techniques. These and other embodiments can effectively overcome problems associated with a lack of depth information and presence of occlusions, shadows, and/or noise.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

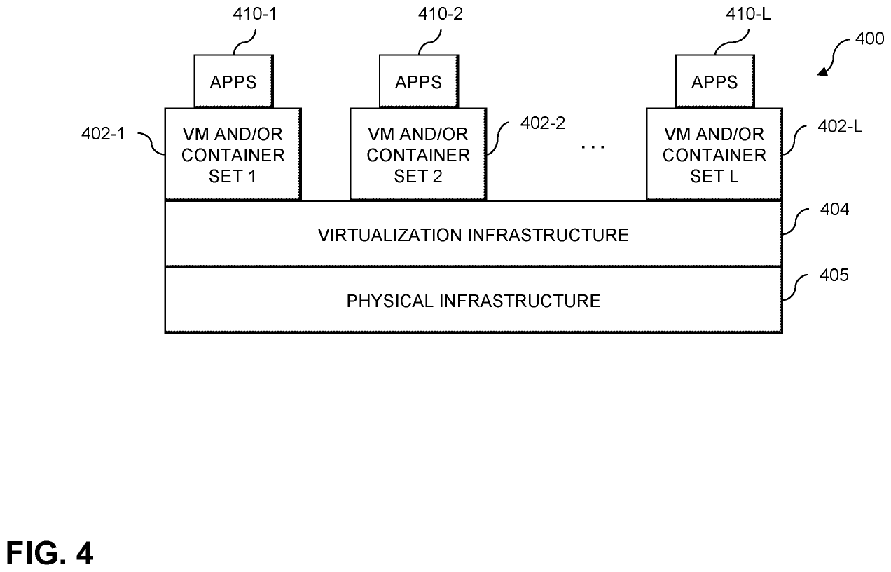

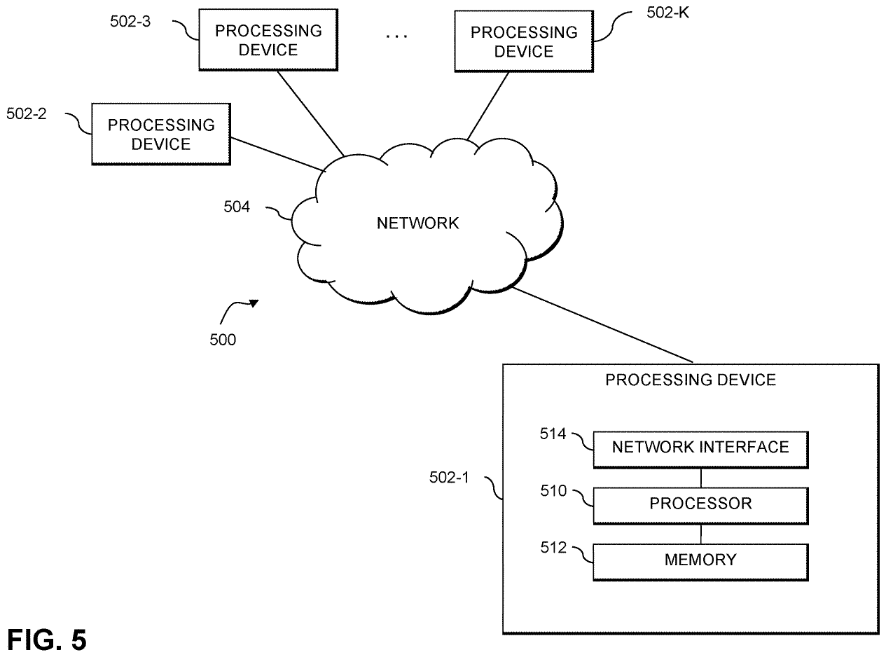

Illustrative embodiments of processing platforms will now be described in greater detail with reference to FIGS. 4 and 5. Although described in the context of system 100, these platforms may also be used to implement at least portions of other information processing systems in other embodiments.

FIG. 4 shows an example processing platform comprising cloud infrastructure 400. The cloud infrastructure 400 comprises a combination of physical and virtual processing resources that are utilized to implement at least a portion of the information processing system 100. The cloud infrastructure 400 comprises multiple virtual machines (VMs) and/or container sets 402-1, 402-2, . . . 402-L implemented using virtualization infrastructure 404. The virtualization infrastructure 404 runs on physical infrastructure 405, and illustratively comprises one or more hypervisors and/or operating system level virtualization infrastructure. The operating system level virtualization infrastructure illustratively comprises kernel control groups of a Linux operating system or other type of operating system.

The cloud infrastructure 400 further comprises sets of applications 410-1, 410-2, . . . 410-L running on respective ones of the VMs/container sets 402-1, 402-2, . . . 402-L under the control of the virtualization infrastructure 404. The VMs/container sets 402 comprise respective VMs, respective sets of one or more containers, or respective sets of one or more containers running in VMs. In some implementations of the FIG. 4 embodiment, the VMs/container sets 402 comprise respective VMs implemented using virtualization infrastructure 404 that comprises at least one hypervisor.

A hypervisor platform may be used to implement a hypervisor within the virtualization infrastructure 404, wherein the hypervisor platform has an associated virtual infrastructure management system. The underlying physical machines comprise one or more information processing platforms that include one or more storage systems.

In other implementations of the FIG. 4 embodiment, the VMs/container sets 402 comprise respective containers implemented using virtualization infrastructure 404 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 400 shown in FIG. 4 may represent at least a portion of one processing platform. Another example of such a processing platform is processing platform 500 shown in FIG. 5.

The processing platform 500 in this embodiment comprises a portion of system 100 and includes a plurality of processing devices, denoted 502-1, 502-2, 502-3, . . . 502-K, which communicate with one another over a network 504.

The network 504 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 502-1 in the processing platform 500 comprises a processor 510 coupled to a memory 512.

The processor 510 comprises a microprocessor, a CPU, a GPU, a TPU, a microcontroller, an ASIC, a FPGA or other type of processing circuitry, as well as portions or combinations of such circuitry elements.

The memory 512 comprises RAM, ROM or other types of memory, in any combination. The memory 512 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 502-1 is network interface circuitry 514, which is used to interface the processing device with the network 504 and other system components, and may comprise conventional transceivers.

The other processing devices 502 of the processing platform 500 are assumed to be configured in a manner similar to that shown for processing device 502-1 in the figure.

Again, the particular processing platform 500 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining at least one two-dimensional image;
determining one or more features of the at least one two-dimensional image by processing at least a portion of the at least one two-dimensional image using a first machine learning technique;
generating multiple three-dimensional visualizations associated with the at least a portion of the at least one two-dimensional image by processing at least a portion of the one or more features using one or more generative artificial intelligence techniques;
selecting at least one of the multiple three-dimensional visualizations by processing at least a portion of the multiple three-dimensional visualizations using a second machine learning technique different from the first machine learning technique; and
performing one or more automated actions based at least in part on the at least one selected three-dimensional visualization;
wherein the method is performed by at least one processing device comprising a processor coupled to a memory.

2. The computer-implemented method of claim 1, wherein determining one or more features of the at least one two-dimensional image comprises processing the at least a portion of the at least one two-dimensional image using one or more semantic segmentation techniques.

3. The computer-implemented method of claim 2, wherein processing the at least a portion of the at least one two-dimensional image using one or more semantic segmentation techniques comprises processing the at least a portion of the at least one two-dimensional image using one or more deep neural networks in conjunction with one or more attention mechanisms.

4. The computer-implemented method of claim 1, wherein determining one or more features of the at least one two-dimensional image comprises generating one or more voxel representations of at least portions of the at least one two-dimensional image by processing the at least a portion of the at least one two-dimensional image using at least one shape generator, wherein the at least one shape generator comprises at least one convolutional neural network-transformer model.

5. The computer-implemented method of claim 1, wherein determining one or more features of the at least one two-dimensional image comprises determining one or more textures associated with at least portions of the at least one two-dimensional image by processing the at least a portion of the at least one two-dimensional image using at least one appearance renderer, wherein the at least one appearance renderer comprises one or more graph neural networks and at least one deep reinforcement learning technique.

6. The computer-implemented method of claim 1, wherein generating multiple three-dimensional visualizations associated with the at least a portion of the at least one two-dimensional image comprises processing the at least a portion of the one or more features using one or more generative adversarial networks.

7. The computer-implemented method of claim 6, wherein processing the at least a portion of the one or more features using one or more generative adversarial networks comprises implementing at least one an adversarial loss function in connection with the one or more generative adversarial networks.

8. The computer-implemented method of claim 1, wherein performing one or more automated actions comprises automatically training at least a portion of the one or more generative artificial intelligence techniques using the at least one selected three-dimensional visualization.

9. The computer-implemented method of claim 1, wherein the first machine learning technique comprises at least one deep learning algorithm, and wherein the second machine learning technique comprises at least one active learning technique.

10. The computer-implemented method of claim 9, wherein selecting at least one of the multiple three-dimensional visualizations comprises defining at least one informativeness measure and at least one selection function associated with the at least one active learning technique.

11. The computer-implemented method of claim 1, wherein performing one or more automated actions comprises automatically outputting, to one or more user devices associated with the at least one two-dimensional image, the at least one selected three-dimensional visualization.

12. A non-transitory processor-readable storage medium having stored therein program code of one or more software programs, wherein the program code when executed by at least one processing device causes the at least one processing device:
to obtain at least one two-dimensional image;
to determine one or more features of the at least one two-dimensional image by processing at least a portion of the at least one two-dimensional image using a first machine learning technique;
to generate multiple three-dimensional visualizations associated with the at least a portion of the at least one two-dimensional image by processing at least a portion of the one or more features using one or more generative artificial intelligence techniques;
to select at least one of the multiple three-dimensional visualizations by processing at least a portion of the multiple three-dimensional visualizations using a second machine learning technique different from the first machine learning technique; and
to perform one or more automated actions based at least in part on the at least one selected three-dimensional visualization.

13. The non-transitory processor-readable storage medium of claim 12, wherein determining one or more features of the at least one two-dimensional image comprises processing the at least a portion of the at least one two-dimensional image using one or more semantic segmentation techniques.

14. The non-transitory processor-readable storage medium of claim 13, wherein processing the at least a portion of the at least one two-dimensional image using one or more semantic segmentation techniques comprises processing the at least a portion of the at least one two-dimensional image using one or more deep neural networks in conjunction with one or more attention mechanisms.

15. The non-transitory processor-readable storage medium of claim 12, wherein generating multiple three-dimensional visualizations associated with the at least a portion of the at least one two-dimensional image comprises processing the at least a portion of the one or more features using one or more generative adversarial networks.

16. The non-transitory processor-readable storage medium of claim 12, wherein performing one or more automated actions comprises automatically training at least a portion of the one or more generative artificial intelligence techniques using the at least one selected three-dimensional visualization.

17. An apparatus comprising:
at least one processing device comprising a processor coupled to a memory;
the at least one processing device being configured:
to obtain at least one two-dimensional image;
to determine one or more features of the at least one two-dimensional image by processing at least a portion of the at least one two-dimensional image using a first machine learning technique;
to generate multiple three-dimensional visualizations associated with the at least a portion of the at least one two-dimensional image by processing at least a portion of the one or more features using one or more generative artificial intelligence techniques;
to select at least one of the multiple three-dimensional visualizations by processing at least a portion of the multiple three-dimensional visualizations using a second machine learning technique different from the first machine learning technique; and
to perform one or more automated actions based at least in part on the at least one selected three-dimensional visualization.

18. The apparatus of claim 17, wherein determining one or more features of the at least one two-dimensional image comprises processing the at least a portion of the at least one two-dimensional image using one or more semantic segmentation techniques.

19. The apparatus of claim 18, wherein processing the at least a portion of the at least one two-dimensional image using one or more semantic segmentation techniques comprises processing the at least a portion of the at least one two-dimensional image using one or more deep neural networks in conjunction with one or more attention mechanisms.

20. The apparatus of claim 17, wherein generating multiple three-dimensional visualizations associated with the at least a portion of the at least one two-dimensional image comprises processing the at least a portion of the one or more features using one or more generative adversarial networks.
